(19) United States
(12) Patent Application Publication
(10) Pub. No.: US 2024/0190746 A1
(43) Pub. Date: Jun. 13, 2024

(54) MODULARIZED FLUORIDE-CONTAINING WASTEWATER TREATING APPARATUS

(71) Applicant: Guangdong Honhor Semiconductor Equipment Co., Ltd., Foshan City (CN)

(72) Inventors: HSING-CHIN CHUNG, Foshan City (CN); CHANG-CHENG LO, Zhubei City (TW); SHUYING HE, Guangzhou City (CN)

(73) Assignee: Guangdong Honhor Semiconductor Equipment Co., Ltd., Foshan City (CN)

(21) Appl. No.: 18/319,300

(22) Filed: May 17, 2023

(30) Foreign Application Priority Data
Dec. 7, 2022 (TW) 111147071

(51) Int. Cl. C02F 9/20; C02F 1/58

(52) U.S. Cl. CPC C02F 9/20; C02F 1/583; C02F 2101/14

(57) ABSTRACT

The invention discloses a modularized fluoride-containing wastewater treating apparatus, comprising: a fluoride removal module, which is used to remove most of the fluoride in the high-concentration fluoride-containing wastewater transported to the fluoride removal module by cryolite crystallizing to generate a mixture of unextracted cryolite crystals and a low-concentration fluoride-containing wastewater; and an extracting module connected with the fluoride removal module, which is used to extract the mixture of unextracted cryolite crystals and a low-concentration fluoride-containing wastewater to separate cryolite crystals with a water content less than 60% or cryolite crystals with a water content less than 10% and a purity of 95%, a wastewater that meets the discharge standard and a condensed fluoride-containing liquid, wherein the condensed fluoride-containing liquid will be recycled to the fluoride removal module.

This application claims the benefit of Taiwanese application serial No. 111147071, filed on Dec. 7, 2022, the subject matter of which is incorporated herein by reference.

### BACKGROUND OF THE INVENTION

### Field of the Invention

The invention relates in general to a fluoride-containing wastewater treating apparatus, and in particular to a modularized fluoride-containing wastewater treating apparatus.

### Description of the Related Art

With the rapid development of semiconductor, display panel and photovoltaic (solar energy) industries, a large amount of high-concentration fluorine-containing chemical agents must be used in the etching process, for example but not limited to 49% pure hydrofluoric acid or mixed hydrofluoric acid, and the high-concentration fluorine-containing wastewater discharged from the etching process usually has a fluoride concentration greater than 3% by weight (30,000 ppm). The high-concentration fluoride-containing wastewater has strong secondary pollution to the environment. It will cause irreversible negative impacts on ecology if the high-concentration fluoride-containing wastewater is directly discharged into rivers, oceans, or infiltration into groundwater. Therefore, it is urgent to strengthen the treatment of these high-concentration fluoride-containing wastewater.

Most of high-concentration fluoride-containing wastewater generated by the semiconductor, display panel and photovoltaic (solar energy) industries was cleared, transported and chemically treated by outsourcing vendors. However, the process of outsourcing transportation is highly dangerous, and the proper handling rate of outsourcing processing is low, which is prone to cause joint legal problems.

In order to solve the above-mentioned shortcomings, some advanced semiconductor, display panel and photovoltaic (solar energy) manufactures chose to directly build a complex and large-scaled fluoride-containing wastewater treating system in the factory to treat the high concentration fluoride-containing wastewater discharged by the etching process. The fluoride in the high-concentration fluoride-containing wastewater can be removed by the complex and large-scaled fluoride-containing wastewater treating system after coagulation, gelation, and precipitation by adding compounds such as calcium oxide and/or calcium hydroxide that react with fluoride to produce precipitation. However, a large amount of sludge cakes are also produced, which also need to be outsourced for cleaning and transportation, which increases the cost of treatment. Although this treatment method of high-concentration fluorine-containing wastewater can solve the above-mentioned shortcomings of subcontracting treatment, its biggest disadvantage is that a large and complex fluoride-containing wastewater treatment must be customized according to the configuration of apparatuses and spatial layout of each plant. This system not only has a long construction time and high construction cost, but also unable to be quickly replicated, heavily and standardizedly installed in all factories, and a large amount of sludge cakes generated during removing the fluoride in the high-concentration fluoride containing wastewater by the he precipitation method are not worth being recycled and can only be cleaned and transported by outsourcing, which will result in great increase of the treatment cost of fluoride-containing wastewater.

Accordingly, a modularized fluoride-containing wastewater treating apparatus which does not have a complex and large-scaled fluoride-containing wastewater treating system built in the factory, and can be quickly replicated, heavily and standardizedly installed in all factories, and does not produce valueless sludge cake is highly expected by the industry.

### SUMMARY OF THE INVENTION

This invention provides a modularized fluoride-containing wastewater treating apparatus, comprising: a fluoride removal module, which is used to remove most of fluoride in a high-concentration fluoride-containing wastewater transported to the fluoride removal module by cryolite crystallizing to generate a mixture of unextracted cryolite crystals and a low-concentration fluoride-containing wastewater; and an extracting module connected with the fluoride removal module, which is used to extract the mixture of the unextracted cryolite crystals and the low-concentration fluoride-containing wastewater to separate cryolite crystals with a water content less than 60% or cryolite crystals with a water content less than 10% and a purity of 95%, a wastewater that meets the discharge standard and a condensed fluoride-containing liquid, wherein the condensed fluoride-containing liquid will be recycled to the fluoride removal module.

The modularized fluoride-containing wastewater treating apparatus as mentioned above, wherein the fluoride removal module comprises: a first basic module, comprising a fluoride-containing wastewater collecting tank and an adjusting tank, wherein the fluoride-containing wastewater collecting tank is used to collect a high concentration fluoride-containing wastewater, and the adjusting tank is connected with the fluoride-containing wastewater collecting tank and used to adjust the pH value and fluoride concentration of the high concentration fluoride-containing wastewater from the fluoride-containing wastewater collecting tank to generate an adjusted fluoride-containing wastewater with fluoride concentration less than 20% by weight and having a pH value in the range of 3 and 6; and a second basic module connected with the first basic module, comprising a reaction tank, a first reagent feeding tank and second reagent feeding tank, wherein the reaction tank is connected with the adjusting tank of the first basic module, and the first reagent feeding tank and the second reagent feeding tank are respectively connected with the reaction tank, and the first reagent feeding is stored with a mixture of a sodium salt solution and an aluminium salt solution, and the second reagent feeding tank is stored with a basic solution, and the first reagent feeding tank and the second reagent feeding tank are respectively open to make the mixture of the sodium salt solution and the aluminium salt solution from the first reagent tank and the basic solution from the second reagent feeding tank flow into the reaction tank when the adjusted fluoride-containing wastewater from the adjusting tank of the first basic module is transported to the reaction tank to generate a reaction solution with a pH value in the range of 3 and 6 after stirring, and generate a mixture of unextracted cryolite crystals and a low-concentration fluoride-containing wastewater by cryolite crystallizing; wherein the fluoride concentration of the low-concentration fluoride-containing wastewater is lower than that of the high-concentration fluoride-containing wastewater.

The modularized fluoride-containing wastewater treating apparatus as mentioned above, wherein the sodium salt is a water-soluble sodium salt selected from one of the group consisting of sodium carbonate, sodium hydroxide, sodium sulfate and sodium nitrite, or combinations thereof.

The modularized fluoride-containing wastewater treating apparatus as mentioned above, wherein the aluminium salt is a water-soluble aluminium salt selected from one of the group consisting of aluminium hydroxide, aluminium sulfate and aluminium nitrite, or combination thereof.

The modularized fluoride-containing wastewater treating apparatus as mentioned above, wherein the mole ratio between sodium ions, aluminium ions and fluoride ions in the reaction solution is 3:1:6.

The modularized fluoride-containing wastewater treating apparatus as mentioned above, the adjusting tank is made of polytetrafluoroethylene (PTFE).

The modularized fluoride-containing wastewater treating apparatus as mentioned above, wherein the reaction tank is a fluidized crystallization bed with a plurality of carriers, and the unextracted cryolite crystals are grown on the carriers.

The modularized fluoride-containing wastewater treating apparatus as mentioned above, wherein the reaction tank is made of polytetrafluoroethylene (PTFE) and corrosion resisting stainless.

The modularized fluoride-containing wastewater treating apparatus as mentioned above, wherein the first reagent feeding tank and the second reagent feeding tank are made of fiber-reinforced plastic (FRP).

The modularized fluoride-containing wastewater treating apparatus as mentioned above, wherein the second basic module further comprises a reaction solution storage tank connected with the reaction tank to temporarily store the mixture of unextracted cryolite crystals and the low-concentration fluoride-containing wastewater generate by the reaction tank.

The modularized fluoride-containing wastewater treating apparatus as mentioned above, wherein the extracting module further comprises a third basic module connected with the second basic module of the fluoride removal module, comprising: a dehydrator connected with the reaction tank or the reaction solution storage tank of the second basic module; a cryolite crystals collecting tank connected with the dehydrator; a filtrate collecting tank connected with the dehydrator; and a filtrate concentrator connected with the filtrate collecting tank and the fluoride-containing wastewater collecting tank of the first basic module; wherein the mixture of unextracted cryolite crystals and the low-concentration fluoride-containing wastewater transported from the reaction tank or the reaction solution storage tank is separated into cryolite crystals with a water content less than 60% and a filtrate by the dehydrator, and the cryolite crystals with a water content less than 60% is transported to the cryolite crystals collecting tank to temporarily stored, and the filtrate is transported to the filtrate collecting tank to temporarily stored and transported to the filtrate concentrator thereafter to concentrate to generate a wastewater that meets the discharge standard and a condensed fluoride-containing liquid, wherein the condensed fluoride-containing liquid will be recycled to the fluoride-containing wastewater collecting tank of the first basic module of the fluoride removal module; wherein the fluoride concentration of the filtrate is lower than that of the high-concentration fluoride-containing wastewater, and the fluoride concentration of the filtrate is lower than that of the condensed fluoride-containing liquid.

The modularized fluoride-containing wastewater treating apparatus as mentioned above, wherein the third basic module further comprises a cryolite crystals drier connected with the cryolite crystals collecting tank, and the cryolite crystals with a water content less than 60% transported from the cryolite crystals collecting tank to the cryolite crystals drier are subsequent dried to generate cryolite crystals with a water content less than 10% and a purity of 95%.

The modularized fluoride-containing wastewater treating apparatus as mentioned above, wherein the third basic module further comprises a cryolite crystals package apparatus connected with the third basic module further comprises a cryolite crystals drier to package the cryolite crystals with a water content less than 10% and a purity of 95% generate by the cryolite crystals drier.

The modularized fluoride-containing wastewater treating apparatus as mentioned above, wherein the third basic module further comprises a condensed fluoride-containing liquid collecting tank connected with the filtrate concentrator and the fluoride-containing wastewater collecting tank of the first basic module, wherein the condensed fluoride-containing liquid generated by the filtrate concentrator is temporarily stored in the condensed fluoride-containing liquid collecting tank and recycled to the fluoride-containing wastewater collecting tank of the first basic module of the fluoride removal module.

### BRIEF DESCRIPTION OF THE DRAWINGS

FIG. 1 illustrates a schematic diagram of modularized fluoride-containing wastewater treating apparatus 10, 20, 30, 40, 50, 60, 70 and 80 according to this present invention.

FIG. 2 illustrates a schematic diagram of a fluoride removal module 200 applicable for the modularized fluoride-containing wastewater treating apparatus 10, 20, 30, 40, 50, 60, 70 and 80 shown in FIG. 1.

FIG. 3 illustrates a schematic diagram of another fluoride removal module 200′ applicable for the modularized fluoride-containing wastewater treating apparatus 10, 20, 30, 40, 50, 60, 70 and 80 shown in FIG. 1.

FIG. 4 illustrates a schematic diagram of an extracting module 300 applicable for the modularized fluoride-containing wastewater treating apparatus 10, 20, 30, 40, 50, 60, 70 and 80 shown in FIG. 1.

FIG. 5 illustrates a schematic diagram of an extracting module 300′ applicable for the modularized fluoride-containing wastewater treating apparatus 10, 20, 30, 40, 50, 60, 70 and 80 shown in FIG. 1.

FIG. 6 illustrates a schematic diagram of an extracting module 300″ applicable for the modularized fluoride-containing wastewater treating apparatus 10, 20, 30, 40, 50, 60, 70 and 80 shown in FIG. 1.

FIG. 7 illustrates a schematic diagram of an extracting module 300″ applicable for the modularized fluoride-containing wastewater treating apparatus 10, 20, 30, 40, 50, 60, 70 and 80 shown in FIG. 1.

FIG. 8 illustrates a schematic diagram of the modularized fluoride-containing wastewater treating apparatus 10 according to Embodiment 1 of this present invention.

FIG. 9 illustrates a schematic diagram of the modularized fluoride-containing wastewater treating apparatus 20 according to Embodiment 2 of this present invention.

FIG. 10 illustrates a schematic diagram of the modularized fluoride-containing wastewater treating apparatus 30 according to Embodiment 3 of this present invention.

FIG. 11 illustrates a schematic diagram of the modularized fluoride-containing wastewater treating apparatus 40 according to Embodiment 4 of this present invention.

FIG. 12 illustrates a schematic diagram of the modularized fluoride-containing wastewater treating apparatus 50 according to Embodiment 5 of this present invention.

FIG. 13 illustrates a schematic diagram of the modularized fluoride-containing wastewater treating apparatus 60 according to Embodiment 6 of this present invention.

FIG. 14 illustrates a schematic diagram of the modularized fluoride-containing wastewater treating apparatus 70 according to Embodiment 7 of this present invention.

FIG. 15 illustrates a schematic diagram of the modularized fluoride-containing wastewater treating apparatus 80 according to Embodiment 8 of this present invention.

### DETAILED DESCRIPTION OF THE INVENTION

The detailed description provided below in connection with the appended drawings is intended as a description of the present examples and is not intended to represent the only forms in which the present example may be constructed or utilized. The description sets forth the functions of the example and the sequence of steps for constructing and operation the example. However, the same or equivalent functions and sequences may be accomplished by different examples.

In the following description, numerous specific details are described in detail in order to enable the reader to fully understand the following examples. However, embodiments of the present invention may be practiced in case no such specific details. In other cases, in order to simplify the drawings the structure of the apparatus known only schematically depicted in figures.

### EMBODIMENT

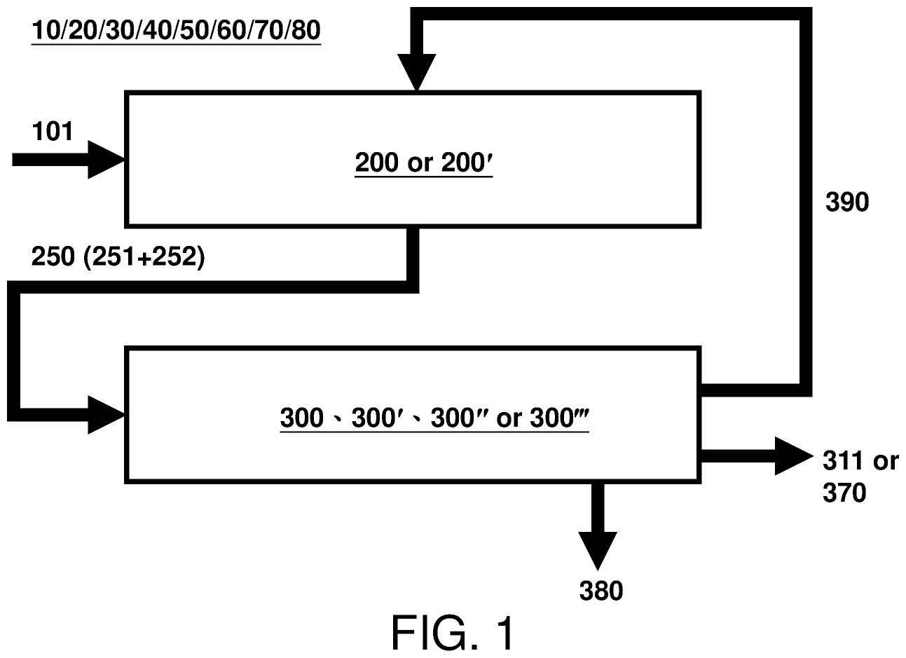

First, please refer to FIG. 1, which illustrates a schematic diagram of modularized fluoride-containing wastewater treating apparatus 10, 20, 30, 40, 50, 60, 70 and 80 according to this present invention, comprising a fluoride removal module 200 or 200′ and an extracting module 300, 300′, 300″ or 300″ connected with the fluoride removal module 200 or 200′, wherein the fluoride removal module 200 or 200′ is used to remove most of fluoride in a high-concentration fluoride-containing wastewater 101 transported to the fluoride removal module 200 or 200′ by cryolite crystallizing to generate a mixture 250 of unextracted cryolite crystals 251 and a low-concentration fluoride-containing wastewater 252, and the extracting module 300, 300′, 300″ or 300″ is used to extract the mixture 250 of the unextracted cryolite crystals 251 and the low-concentration fluoride-containing wastewater 252 to separate cryolite crystals 311 with a water content less than 60% or cryolite crystals 370 with a water content less than 10% and a purity of 95%, a wastewater 380 that meets the discharge standard and a condensed fluoride-containing liquid 390, and the condensed fluoride-containing liquid 390 will be recycled to the fluoride removal module. The high-concentration fluoride-containing wastewater 101 can be for example but not limited to the hydrofluoric acid solution, and the fluoride concentration of the low-concentration fluoride-containing wastewater 252 is lower than that of the high-concentration fluoride-containing wastewater 101, and the fluoride concentration of the low-concentration fluoride-containing wastewater 252 is also lower than that of the condensed fluoride-containing liquid 390.

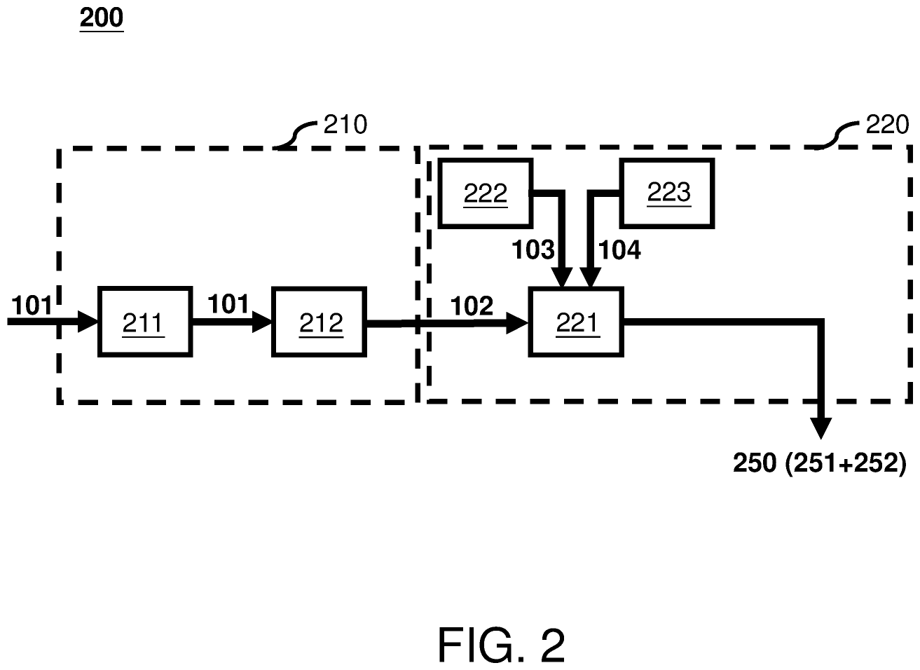

Next, please refer to FIG. 2, which illustrates a schematic diagram of a fluoride removal module 200 applicable for the modularized fluoride-containing wastewater treating apparatus 10, 20, 30, 40, 50, 60, 70 and 80 shown in FIG. 1. As shown in FIG. 2, the fluoride removal module 200 comprises a first basic module 210, comprising a fluoride-containing wastewater collecting tank 211 and an adjusting tank 212, wherein the fluoride-containing wastewater collecting tank 211 is used to collect a high concentration fluoride-containing wastewater 101, and the adjusting tank 212 is connected with the fluoride-containing wastewater collecting tank 211 and used to adjust the pH value and fluoride concentration of the high concentration fluoride-containing wastewater 101 from the fluoride-containing wastewater collecting tank 211 to generate an adjusted fluoride-containing wastewater 102 with fluoride concentration less than 20% by weight and having a pH value in the range of 3 and 6; and a second basic module 220 connected with the first basic module 210, comprising a reaction tank 221, a first reagent feeding tank 222 and second reagent feeding tank 223, wherein the reaction tank 211 is connected with the adjusting tank 212 of the first basic module 210, and the first reagent feeding tank 222 and the second reagent feeding tank 223 are respectively connected with the reaction tank 221, and the first reagent feeding 222 is stored with a mixture 103 of a sodium salt solution and an aluminium salt solution, and the second reagent feeding tank 223 is stored with a basic solution 104, and the first reagent feeding tank 222 and the second reagent feeding tank 223 are respectively open to make the mixture 103 of the sodium salt solution and the aluminium salt solution from the first reagent tank 222 and the basic solution 104 from the second reagent feeding tank 223 flow into the reaction tank 221 when the adjusted fluoride-containing wastewater 102 from the adjusting tank 212 of the first basic module 210 is transported to the reaction tank 221 to generate a reaction solution (not labeled) with a pH value in the range of 3 and 6 after stirring, and generate a mixture 250 of unextracted cryolite crystals 251 and a low-concentration fluoride-containing wastewater 252 by cryolite crystallizing; wherein the fluoride concentration of the low-concentration fluoride-containing wastewater 252 is lower than that of the high-concentration fluoride-containing wastewater 101.

The mixture 103 of a sodium salt solution and an aluminium salt solution as mentioned above, wherein the sodium salt is a water-soluble sodium salt selected from one of the group consisting of sodium carbonate, sodium hydroxide, sodium sulfate and sodium nitrite, or combinations thereof, and the aluminium salt is a water-soluble aluminium salt selected from one of the group consisting of aluminium hydroxide, aluminium sulfate and aluminium nitrite, or combination thereof. The basic solution 104 can be for example but not limited to a sodium hydroxide solution.

In order to make sure the fluoride in the reaction solution be completely reacted with the sodium ions and aluminium ions, the concentration of the sodium ions and aluminium ions are optionally adjusted, wherein the mole ratio between sodium ions, aluminium ions and fluoride ions in the reaction solution is preferably 3:1:6.

The above-mentioned adjusting tank 212 can be made of for example but not limited to polytetrafluoroethylene (PTFE).

The above-mentioned reaction tank 221 can be a fluidized crystallization bed with a plurality of carriers having a great crystallization specific surface area in the range of 3000˜5000 m²/m³, and the unextracted cryolite crystals 251 are grown on the carriers.

The above-mentioned reaction tank 221 are made of for example but not limited to polytetrafluoroethylene (PTFE) and corrosion resisting stainless.

The above-mentioned first reagent feeding tank 222 and the second reagent feeding tank 223 are made of for example but not limited to fiber-reinforced plastic (FRP).

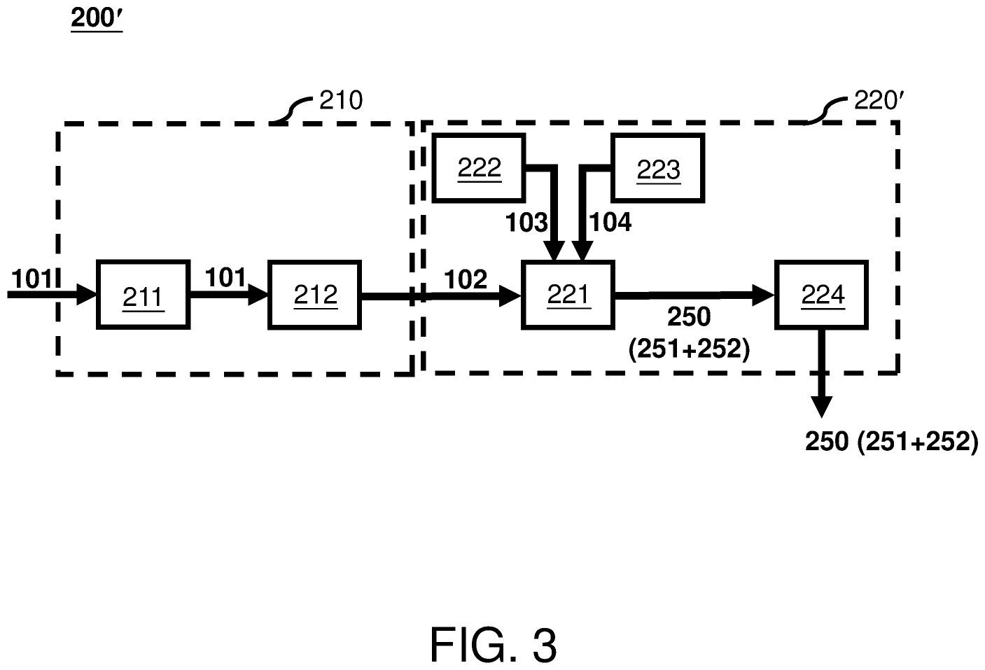

Next, please refer to FIG. 3, which illustrates a schematic diagram of another fluoride removal module 200′ applicable for the modularized fluoride-containing wastewater treating apparatus 10, 20, 30, 40, 50, 60, 70 and 80 shown in FIG. 1. As shown in FIG. 3, the fluoride removal module 200′ comprises a first basic module 210 and a second basic module 220′, wherein the configuration of the first basic module 210 is the same as that shown in FIG. 2, and the configuration of the second basic module 220′ is similar to that of the second basic module 220 as shown in FIG. 2 except that the second basic module 220′ shown in FIG. 3 further comprises a reaction solution storage tank 224 connected with the reaction tank 221 which is used to temporarily store the mixture 250 of unextracted cryolite crystals 251 and a low-concentration fluoride-containing wastewater 252 generated by the reaction tank 221.

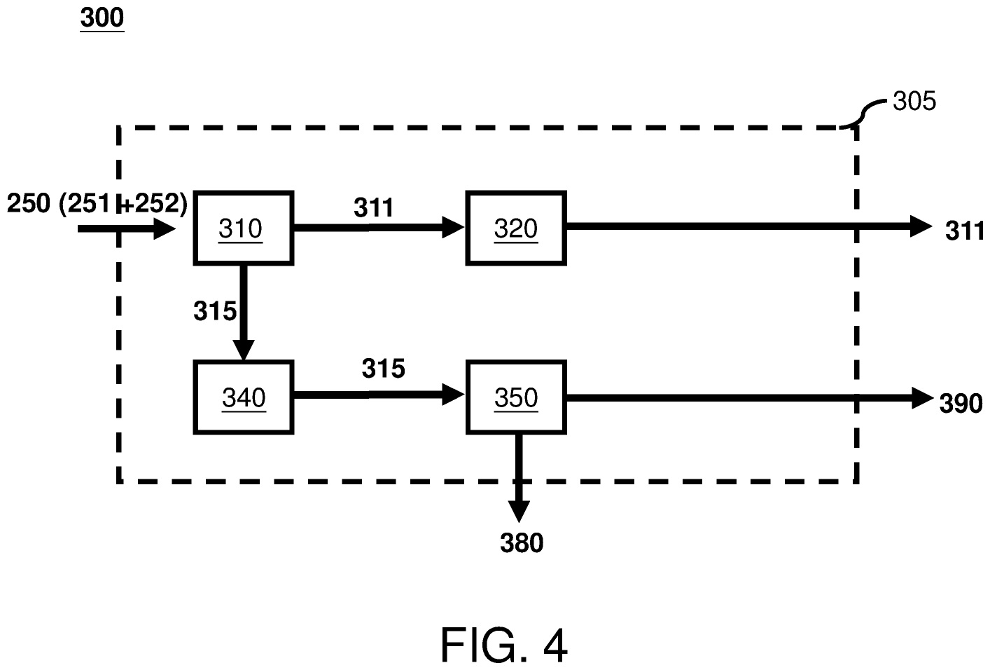

Next, please refer to FIG. 4, which illustrates a schematic diagram of an extracting module 300 applicable for the modularized fluoride-containing wastewater treating apparatus 10, 20, 30, 40, 50, 60, 70 and 80 shown in FIG. 1. As shown in FIG. 4, the extracting module 300 comprises a third basic module 305 connected with the second basic module 220 of the fluoride removal module 200 shown in FIG. 2 or the second basic module 220′ of the fluoride removal module 200′ shown in FIG. 3, comprising a dehydrator 310 connected with the reaction tank 221 of the second basic module 220 or connected with the reaction solution storage tank 224 of the second basic module 220′, a cryolite crystals collecting tank 320 connected with the dehydrator 310, a filtrate collecting tank 340 connected with the dehydrator 310, and a filtrate concentrator 350 connected with the filtrate collecting tank 340 and the fluoride-containing wastewater collecting tank 211 of the first basic module 210. The mixture 250 of unextracted cryolite crystals 251 and the low-concentration fluoride-containing wastewater 252 transported from the reaction tank 221 or the reaction solution storage tank 224 was separated into cryolite crystals 311 with a water content less than 60% and a filtrate 315 by the dehydrator 310, and the cryolite crystals 311 with a water content less than 60% was transported to the cryolite crystals collecting tank 320 to temporarily stored, and the filtrate 315 was transported to the filtrate collecting tank 340 to temporarily stored and transported to the filtrate concentrator 350 thereafter to concentrate to generate a wastewater 380 that meets the discharge standard and a condensed fluoride-containing liquid 390, then the condensed fluoride-containing liquid 390 was recycled to the fluoride-containing wastewater collecting tank 212 of the first basic module 210 of the fluoride removal module 200 thereafter. The fluoride concentration of the filtrate 315 is lower than that of the high-concentration fluoride-containing wastewater 101, and the fluoride concentration of the filtrate 315 is lower than that of the condensed fluoride-containing liquid 390.

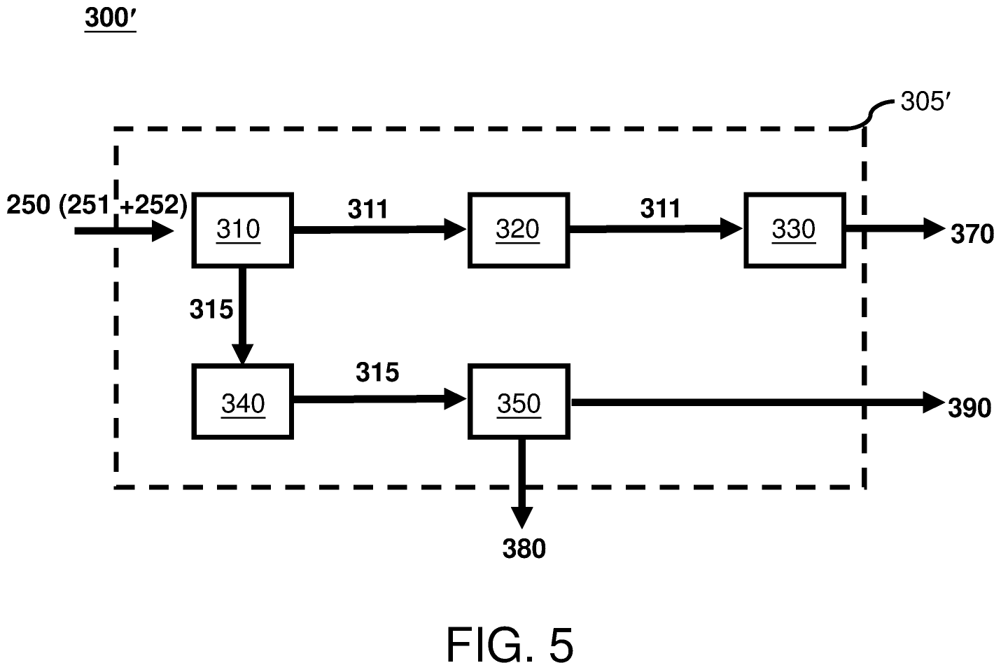

Next, please refer to FIG. 5, which illustrates a schematic diagram of another extracting module 300′ applicable for the modularized fluoride-containing wastewater treating apparatus 10, 20, 30, 40, 50, 60, 70 and 80 shown in FIG. 1. As shown in FIG. 5, the configuration of the third basic module 305′ of the extracting module 300′ is similar to that of the third basic module 305 of the extracting module 300 shown in FIG. 4 except that the third basic module 305′ of the extracting module 300′ shown in FIG. 5 further comprises a cryolite crystals drier 330 connected with the cryolite crystals collecting tank 320, and the cryolite crystals 311 with a water content less than 60% transported from the cryolite crystals collecting tank 320 to the cryolite crystals drier were subsequent dried to generate cryolite crystals 370 with a water content less than 10% and a purity of 95%.

Moreover, the third basic module 305′ of the extracting module 300′ shown in FIG. 5 can further comprise a cryolite crystals package apparatus (not shown) connected with the cryolite crystals drier 330 to package the cryolite crystals 370 with a water content less than 10% and a purity of 95% generate by the cryolite crystals drier 330.

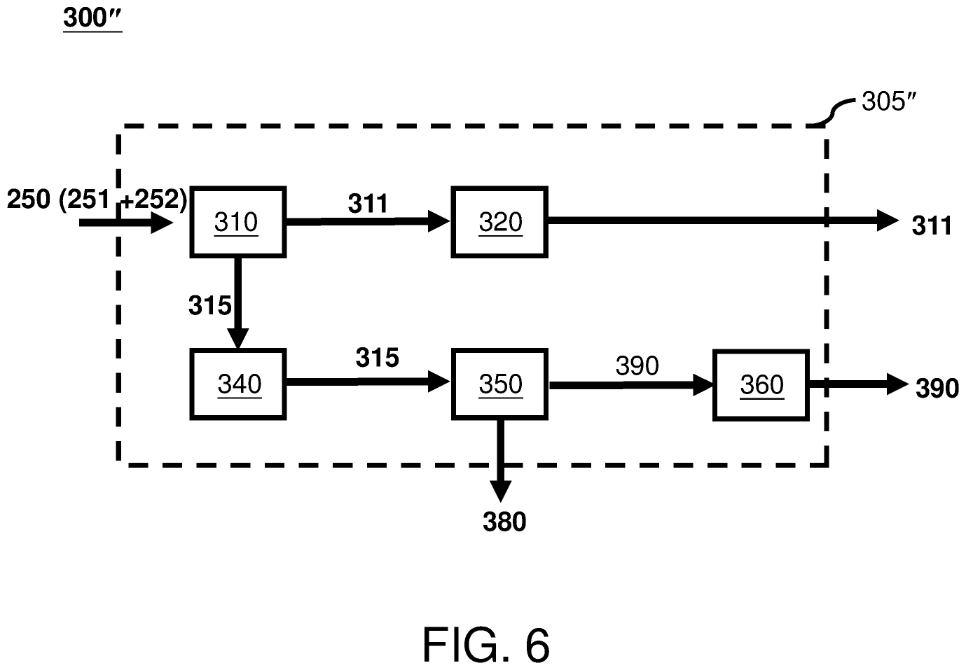

Next, please refer to FIG. 6, which illustrates a schematic diagram of another extracting module 300″ applicable for the modularized fluoride-containing wastewater treating apparatus 10, 20, 30, 40, 50, 60, 70 and 80 shown in FIG. 1. As shown in FIG. 6, the configuration of the third basic module 305″ of the extracting module 300″ is similar to that of the third basic module 305 of the extracting module 300 shown in FIG. 4 except that the third basic module 305′ of the extracting module 300′ shown in FIG. 5 further comprises a condensed fluoride-containing liquid collecting tank 360 connected with the filtrate concentrator 350 and the fluoride-containing wastewater collecting tank 211 of the first basic module 210 of the fluoride removal module 200 or 200′, wherein the condensed fluoride-containing liquid 390 generated by the filtrate concentrator 350 is temporarily stored in the condensed fluoride-containing liquid collecting tank 360 and recycled to the fluoride-containing wastewater collecting tank 211 of the first basic module 210 of the fluoride removal module 200 or 200′.

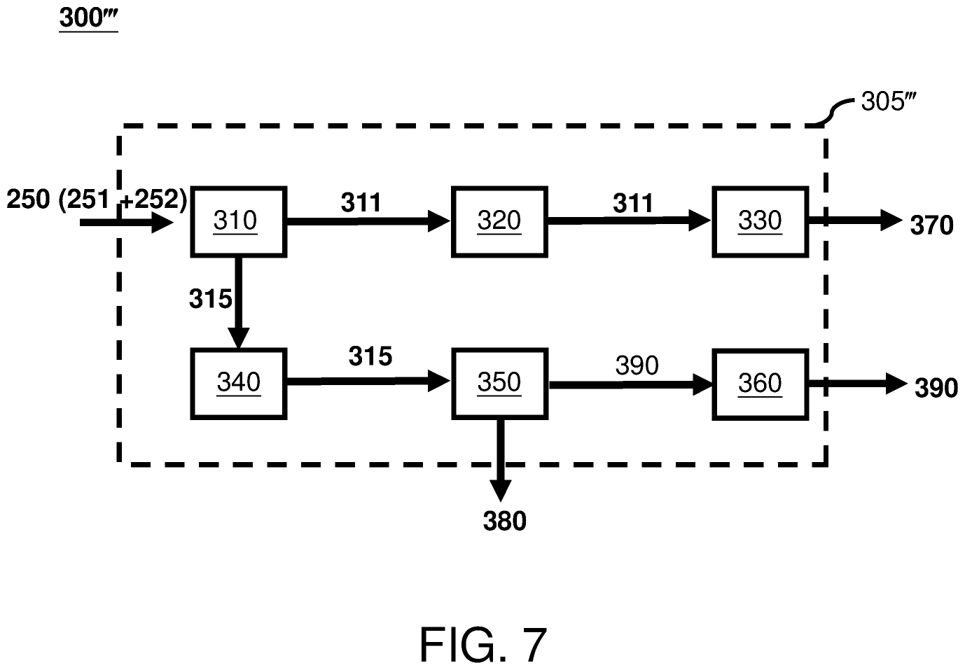

Next, please refer to FIG. 7, which illustrates a schematic diagram of another extracting module 300″ applicable for the modularized fluoride-containing wastewater treating apparatus 10, 20, 30, 40, 50, 60, 70 and 80 shown in FIG. 1. As shown in FIG. 7, the configuration of the third basic module 305″ of the extracting module 300″ is similar to that of the third basic module 305′ of the extracting module 300′ shown in FIG. 5 except that the third basic module 305″ of the extracting module 300″ shown in FIG. 7 further comprises a condensed fluoride-containing liquid collecting tank 360 connected with the filtrate concentrator 350 and the fluoride-containing wastewater collecting tank 211 of the first basic module 210 of the fluoride removal module 200 or 200′, wherein the condensed fluoride-containing liquid 390 generated by the filtrate concentrator 350 is temporarily stored in the condensed fluoride-containing liquid collecting tank 360 and recycled to the fluoride-containing wastewater collecting tank 211 of the first basic module 210 of the fluoride removal module 200 or 200′.

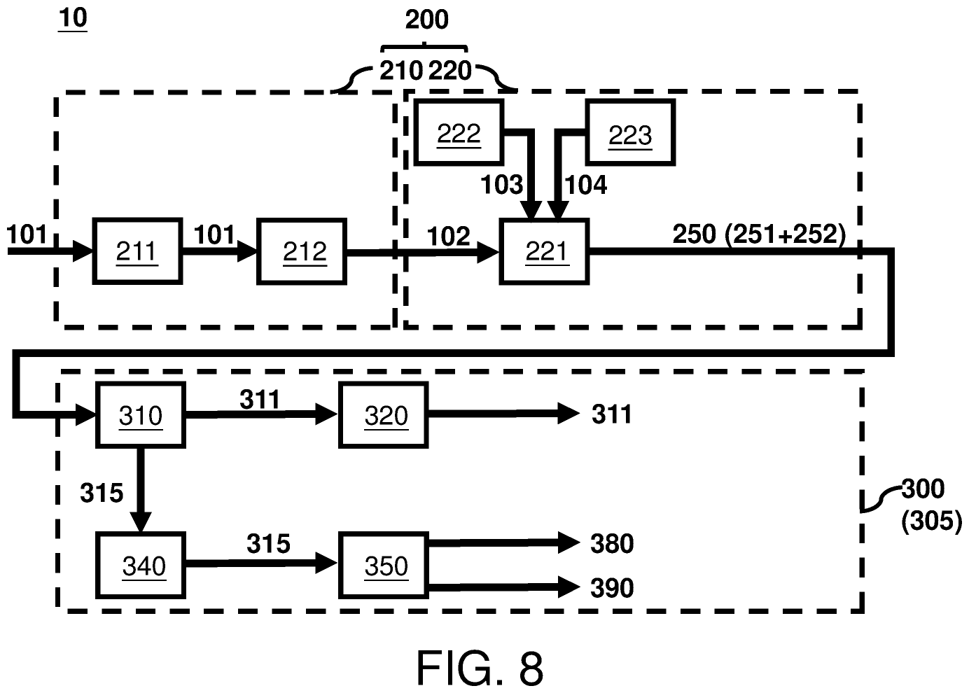

Embodiments 1˜8 of this present invention will be described below in connection with the appended drawings FIGS. 8˜15.

### Embodiment 1

Please refer to FIG. 8, which illustrates a schematic diagram of the modularized fluoride-containing wastewater treating apparatus 10 according to Embodiment 1 of this present invention. As shown in FIG. 8, the modularized fluoride-containing wastewater treating apparatus 10 comprises a fluoride removal module 200 shown in FIG. 2 and an extracting module 300 shown in FIG. 4. The high concentration fluoride-containing wastewater 101 transported to the fluoride removal module 200 was treated by the first basic module 210 of the fluoride removal module 200 to generate an adjusted fluoride-containing wastewater 102 with fluoride concentration less than 20% by weight and having a pH value in the range of 3 and 6. The adjusted fluoride-containing wastewater 102 was transported to the second basic module 220 of the fluoride removal module 200 and well-stirred with the mixture 103 of the sodium salt solution and the aluminium salt solution from the first reagent tank 222 and the basic solution 104 from the second reagent feeding tank 223 flow into the reaction tank 221 to generate a reaction solution with a pH value in the range of 3 and 6, and generate a mixture 250 of unextracted cryolite crystals 251 and a low-concentration fluoride-containing wastewater 252 to remove most of fluoride in the high concentration fluoride-containing wastewater 101 by cryolite crystallizing in the reaction tank 221.

Next, as shown in FIG. 8, the mixture 250 of unextracted cryolite crystals 251 and a low-concentration fluoride-containing wastewater 252 was transported to the third basic module 305 of the extracting module 300 to separate into cryolite crystals 311 with a water content less than 60% and a filtrate 315 by the dehydrator 310. The cryolite crystals 311 with a water content less than 60% was transported to the cryolite crystals collecting tank 320 to temporarily stored, and the filtrate 315 was transported to the filtrate collecting tank 340 to temporarily stored and transported to the filtrate concentrator 350 thereafter to concentrate to generate a wastewater 380 that meets the discharge standard and a condensed fluoride-containing liquid 390. The condensed fluoride-containing liquid 390 was recycled to the fluoride-containing wastewater collecting tank 212 of the first basic module 210 of the fluoride removal module 200 thereafter.

When a high concentration fluoride-containing wastewater 101 having a fluoride concentration higher than for example 15% by weight (150000 ppm) was treated by the modularized fluoride-containing wastewater treating apparatus 10 of Embodiment of this present invention, a low-concentration fluoride-containing wastewater 252 having a fluoride concentration less than 5000 ppm can be generated. A filtrate 315 having a fluoride concentration less than 3000 ppm can be generated when the low-concentration fluoride-containing wastewater 252 having a fluoride concentration less than 5000 ppm was treated by the dehydrator 340 of the third basic module 305 of the extracting module 300. A wastewater 380 having a fluoride concentration less than 5 ppm that meets the discharge standard and a condensed fluoride-containing liquid 390 having a fluoride concentration higher than 3% by weight (30000 ppm) were obtained when the filtrate 315 having a fluoride concentration less than 3000 ppm was further concentrated by the filtrate concentrator 350 of the third basic module 305 of the extracting module 300.

Furthermore, the modularized fluoride-containing wastewater treating apparatus 10 shown in FIG. 8 comprises a fluoride removal module 200 with one first basic module 210 and one second basic module 220, and an extracting module 300 with one third basic module 305, but the fluoride removal module 200 can be equipped with more than one first basic module 210 and second basic module 220, and the extracting module 300 can be equipped with more than one third basic module 305 when the capacity of the high-concentration fluoride-containing wastewater to be treated is large.

### Embodiment 2

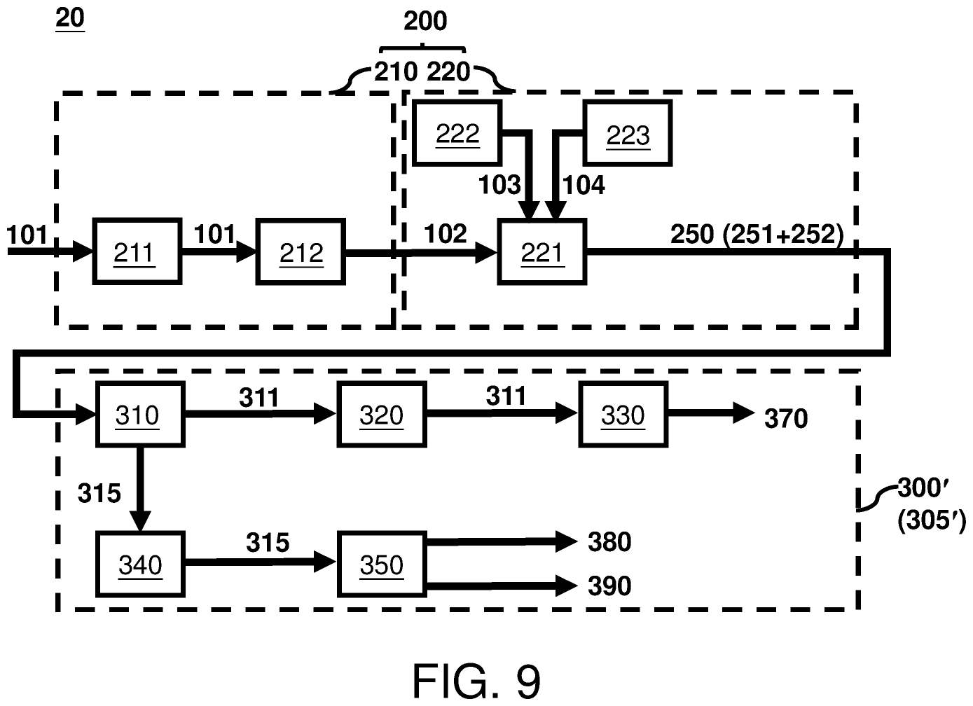

Please refer to FIG. 9, which illustrates a schematic diagram of the modularized fluoride-containing wastewater treating apparatus 20 according to Embodiment 2 of this present invention. As shown in FIG. 9, the modularized fluoride-containing wastewater treating apparatus 20 comprises a fluoride removal module 200 shown in FIG. 2 and an extracting module 300′ shown in FIG. 5. The high concentration fluoride-containing wastewater 101 transported to the fluoride removal module 200 was treated by the first basic module 210 of the fluoride removal module 200 to generate an adjusted fluoride-containing wastewater 102 with fluoride concentration less than 20% by weight and having a pH value in the range of 3 and 6. The adjusted fluoride-containing wastewater 102 was transported to the second basic module 220 of the fluoride removal module 200 and well-stirred with the mixture 103 of the sodium salt solution and the aluminium salt solution from the first reagent tank 222 and the basic solution 104 from the second reagent feeding tank 223 flow into the reaction tank 221 to generate a reaction solution with a pH value in the range of 3 and 6, and generate a mixture 250 of unextracted cryolite crystals 251 and a low-concentration fluoride-containing wastewater 252 to remove most of fluoride in the high concentration fluoride-containing wastewater 101 by cryolite crystallizing in the reaction tank 221.

Next, as shown in FIG. 9, the mixture 250 of unextracted cryolite crystals 251 and a low-concentration fluoride-containing wastewater 252 was transported to the third basic module 305′ of the extracting module 300′ to separate into cryolite crystals 311 with a water content less than 60% and a filtrate 315 by the dehydrator 310. The cryolite crystals 311 with a water content less than 60% was transported to the cryolite crystals collecting tank 320 to temporarily stored and then transported to the cryolite crystals drier 330 to dry to generate cryolite crystals 370 with a water content less than 10% and a purity of 95%, and the filtrate 315 was transported to the filtrate collecting tank 340 to temporarily stored and transported to the filtrate concentrator 350 thereafter to concentrate to generate a wastewater 380 that meets the discharge standard and a condensed fluoride-containing liquid 390. The condensed fluoride-containing liquid 390 was recycled to the fluoride-containing wastewater collecting tank 212 of the first basic module 210 of the fluoride removal module 200 thereafter.

When a high concentration fluoride-containing wastewater 101 having a fluoride concentration higher than for example 15% by weight (150000 ppm) was treated by the modularized fluoride-containing wastewater treating apparatus 20 of Embodiment of this present invention, a low-concentration fluoride-containing wastewater 252 having a fluoride concentration less than 5000 ppm can be generated. A filtrate 315 having a fluoride concentration less than 3000 ppm and cryolite crystals 370 with a water content less than 10% and a purity of 95% can be generated when the low-concentration fluoride-containing wastewater 252 having a fluoride concentration less than 5000 ppm was treated by the dehydrator 340 of the third basic module 305′ of the extracting module 300′. A wastewater 380 having a fluoride concentration less than 5 ppm that meets the discharge standard and a condensed fluoride-containing liquid 390 having a fluoride concentration higher than 3% by weight (30000 ppm) were obtained when the filtrate 315 having a fluoride concentration less than 3000 ppm was further concentrated by the filtrate concentrator 350 of the third basic module 305′ of the extracting module 300′.

Moreover, the third basic module 305′ of the extracting module 300′ of this present Embodiment 2 can further comprise a cryolite crystals package apparatus (not shown) connected with the cryolite crystals drier 330 to package the cryolite crystals 370 with a water content less than 10% and a purity of 95%.

Furthermore, the modularized fluoride-containing wastewater treating apparatus 20 shown in FIG. 9 comprises a fluoride removal module 200 with one first basic module 210 and one second basic module 220, and an extracting module 300′ with one third basic module 305′, but the fluoride removal module 200 can be equipped with more than one first basic module 210 and second basic module 220, and the extracting module 300′ can be equipped with more than one third basic module 305′ when the capacity of the high-concentration fluoride-containing wastewater to be treated is large.

### Embodiment 3

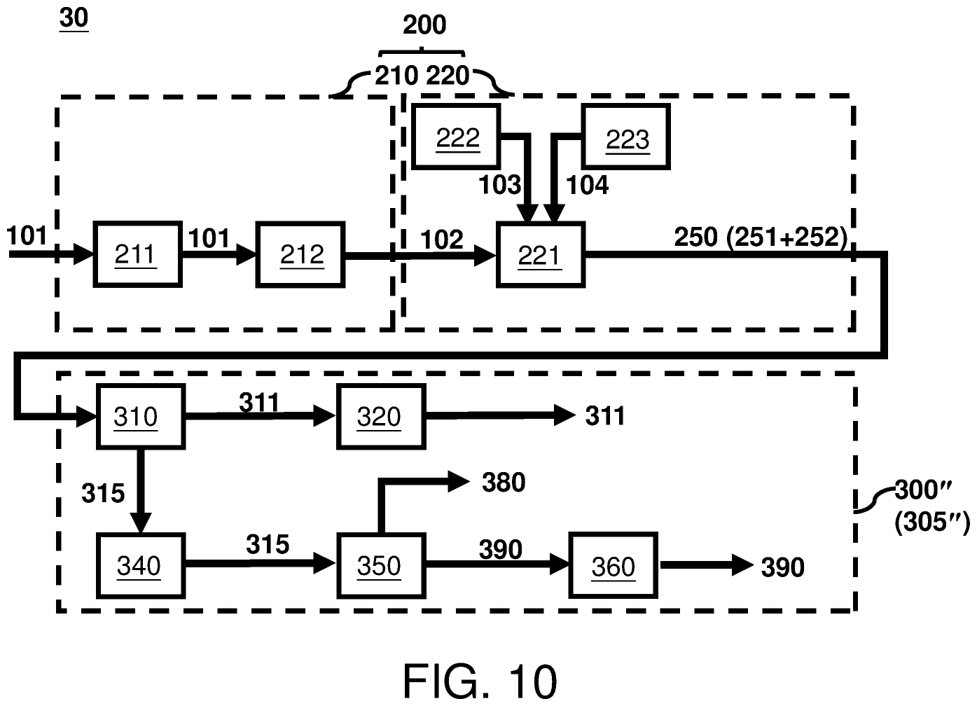

Please refer to FIG. 10, which illustrates a schematic diagram of the modularized fluoride-containing wastewater treating apparatus 30 according to Embodiment 3 of this present invention. As shown in FIG. 10, the modularized fluoride-containing wastewater treating apparatus 30 comprises a fluoride removal module 200 shown in FIG. 2 and an extracting module 300″ shown in FIG. 6. The high concentration fluoride-containing wastewater 101 transported to the fluoride removal module 200 was treated by the first basic module 210 of the fluoride removal module 200 to generate an adjusted fluoride-containing wastewater 102 with fluoride concentration less than 20% by weight and having a pH value in the range of 3 and 6. The adjusted fluoride-containing wastewater 102 was transported to the second basic module 220 of the fluoride removal module 200 and well-stirred with the mixture 103 of the sodium salt solution and the aluminium salt solution from the first reagent tank 222 and the basic solution 104 from the second reagent feeding tank 223 flow into the reaction tank 221 to generate a reaction solution with a pH value in the range of 3 and 6, and generate a mixture 250 of unextracted cryolite crystals 251 and a low-concentration fluoride-containing wastewater 252 to remove most of fluoride in the high concentration fluoride-containing wastewater 101 by cryolite crystallizing in the reaction tank 221.

Next, as shown in FIG. 10, the mixture 250 of unextracted cryolite crystals 251 and a low-concentration fluoride-containing wastewater 252 was transported to the third basic module 305″ of the extracting module 300″ to separate into cryolite crystals 311 with a water content less than 60% and a filtrate 315 by the dehydrator 310. The cryolite crystals 311 with a water content less than 60% was transported to the cryolite crystals collecting tank 320 to temporarily stored and then transported to the cryolite crystals drier 330 to dry to generate cryolite crystals 370 with a water content less than 10% and a purity of 95%, and the filtrate 315 was transported to the filtrate collecting tank 340 to temporarily stored and transported to the filtrate concentrator 350 thereafter to concentrate to generate a wastewater 380 that meets the discharge standard and a condensed fluoride-containing liquid 390. The condensed fluoride-containing liquid 390 stored in a condensed fluoride-containing liquid collecting tank 360. The condensed fluoride-containing liquid 390 was recycled from the condensed fluoride-containing liquid collecting tank 360 to the fluoride-containing wastewater collecting tank 212 of the first basic module 210 of the fluoride removal module 200 thereafter.

When a high concentration fluoride-containing wastewater 101 having a fluoride concentration higher than for example 15% by weight (150000 ppm) was treated by the modularized fluoride-containing wastewater treating apparatus 30 of Embodiment of this present invention, a low-concentration fluoride-containing wastewater 252 having a fluoride concentration less than 5000 ppm can be generated. A filtrate 315 having a fluoride concentration less than 3000 ppm can be generated when the low-concentration fluoride-containing wastewater 252 having a fluoride concentration less than 5000 ppm was treated by the dehydrator 340 of the third basic module 305″ of the extracting module 300″. A wastewater 380 having a fluoride concentration less than 5 ppm that meets the discharge standard and a condensed fluoride-containing liquid 390 having a fluoride concentration higher than 3% by weight (30000 ppm) were obtained when the filtrate 315 having a fluoride concentration less than 3000 ppm was further concentrated by the filtrate concentrator 350 of the third basic module 305″ of the extracting module 300″.

Furthermore, the modularized fluoride-containing wastewater treating apparatus 30 shown in FIG. 10 comprises a fluoride removal module 200 with one first basic module 210 and one second basic module 220, and an extracting module 300″ with one third basic module 305″, but the fluoride removal module 200 can be equipped with more than one first basic module 210 and second basic module 220, and the extracting module 300″ can be equipped with more than one third basic module 305″ when the capacity of the high-concentration fluoride-containing wastewater to be treated is large.

### Embodiment 4

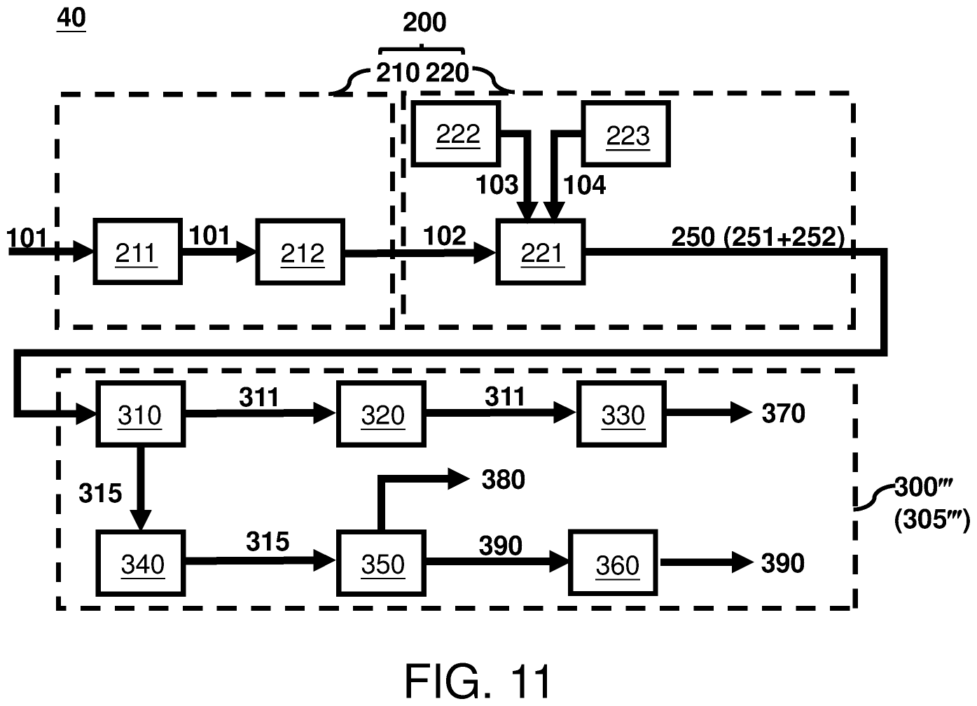

Please refer to FIG. 11, which illustrates a schematic diagram of the modularized fluoride-containing wastewater treating apparatus 40 according to Embodiment 4 of this present invention. As shown in FIG. 11, the modularized fluoride-containing wastewater treating apparatus 40 comprises a fluoride removal module 200 shown in FIG. 2 and an extracting module 300″ shown in FIG. 7. The high concentration fluoride-containing wastewater 101 transported to the fluoride removal module 200 was treated by the first basic module 210 of the fluoride removal module 200 to generate an adjusted fluoride-containing wastewater 102 with fluoride concentration less than 20% by weight and having a pH value in the range of 3 and 6. The adjusted fluoride-containing wastewater 102 was transported to the second basic module 220 of the fluoride removal module 200 and well-stirred with the mixture 103 of the sodium salt solution and the aluminium salt solution from the first reagent tank 222 and the basic solution 104 from the second reagent feeding tank 223 flow into the reaction tank 221 to generate a reaction solution with a pH value in the range of 3 and 6, and generate a mixture 250 of unextracted cryolite crystals 251 and a low-concentration fluoride-containing wastewater 252 to remove most of fluoride in the high concentration fluoride-containing wastewater 101 by cryolite crystallizing in the reaction tank 221.

Next, as shown in FIG. 11, the mixture 250 of unextracted cryolite crystals 251 and a low-concentration fluoride-containing wastewater 252 was transported to the third basic module 305″ of the extracting module 300″ to separate into cryolite crystals 311 with a water content less than 60% and a filtrate 315 by the dehydrator 310. The cryolite crystals 311 with a water content less than 60% was transported to the cryolite crystals collecting tank 320 to temporarily stored and then transported to the cryolite crystals drier 330 to dry to generate cryolite crystals 370 with a water content less than 10% and a purity of 95%, and the filtrate 315 was transported to the filtrate collecting tank 340 to temporarily stored and transported to the filtrate concentrator 350 thereafter to concentrate to generate a wastewater 380 that meets the discharge standard and a condensed fluoride-containing liquid 390 stored in a condensed fluoride-containing liquid collecting tank 360. The condensed fluoride-containing liquid 390 was recycled from the condensed fluoride-containing liquid collecting tank 360 to the fluoride-containing wastewater collecting tank 212 of the first basic module 210 of the fluoride removal module 200 thereafter.

When a high concentration fluoride-containing wastewater 101 having a fluoride concentration higher than for example 15% by weight (150000 ppm) was treated by the modularized fluoride-containing wastewater treating apparatus 40 of Embodiment of this present invention, a low-concentration fluoride-containing wastewater 252 having a fluoride concentration less than 5000 ppm can be generated. A filtrate 315 having a fluoride concentration less than 3000 ppm and cryolite crystals 370 with a water content less than 10% and a purity of 95% can be generated when the low-concentration fluoride-containing wastewater 252 having a fluoride concentration less than 5000 ppm was treated by the dehydrator 340 of the third basic module 305″ of the extracting module 300″. A wastewater 380 having a fluoride concentration less than 5 ppm that meets the discharge standard and a condensed fluoride-containing liquid 390 having a fluoride concentration higher than 3% by weight (30000 ppm) were obtained when the filtrate 315 having a fluoride concentration less than 3000 ppm was further concentrated by the filtrate concentrator 350 of the third basic module 305″ of the extracting module 300″.

Moreover, the third basic module 305″ of the extracting module 300″ of this present Embodiment 4 can further comprise a cryolite crystals package apparatus (not shown) connected with the cryolite crystals drier 330 to package the cryolite crystals 370 with a water content less than 10% and a purity of 95%.

Furthermore, the modularized fluoride-containing wastewater treating apparatus 40 shown in FIG. 11 comprises a fluoride removal module 200 with one first basic module 210 and one second basic module 220, and an extracting module 300″ with one third basic module 305″, but the fluoride removal module 200 can be equipped with more than one first basic module 210 and second basic module 220, and the extracting module 300″ can be equipped with more than one third basic module 305″ when the capacity of the high-concentration fluoride-containing wastewater to be treated is large.

### Embodiment 5

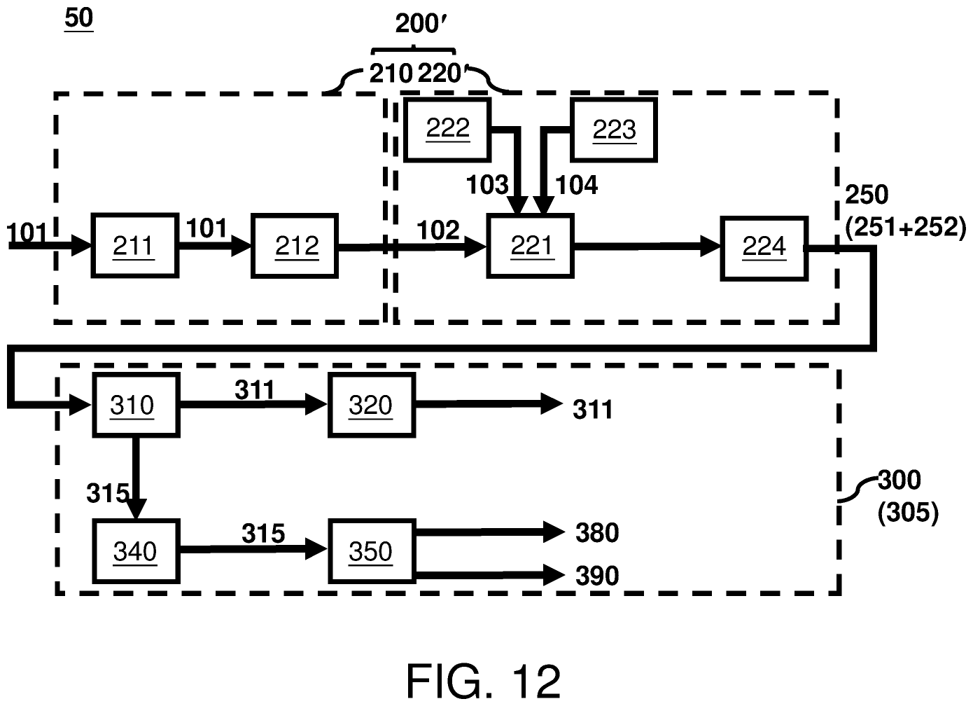

Please refer to FIG. 12, which illustrates a schematic diagram of the modularized fluoride-containing wastewater treating apparatus 50 according to Embodiment 5 of this present invention. As shown in FIG. 12, the modularized fluoride-containing wastewater treating apparatus 10 comprises a fluoride removal module 200′ shown in FIG. 3 and an extracting module 300 shown in FIG. 4. The high concentration fluoride-containing wastewater 101 transported to the fluoride removal module 200′ was treated by the first basic module 210 of the fluoride removal module 200 to generate an adjusted fluoride-containing wastewater 102 with fluoride concentration less than 20% by weight and having a pH value in the range of 3 and 6. The adjusted fluoride-containing wastewater 102 was transported to the second basic module 220′ of the fluoride removal module 200′ and well-stirred with the mixture 103 of the sodium salt solution and the aluminium salt solution from the first reagent tank 222 and the basic solution 104 from the second reagent feeding tank 223 flow into the reaction tank 221 to generate a reaction solution with a pH value in the range of 3 and 6, and generate a mixture 250 of unextracted cryolite crystals 251 and a low-concentration fluoride-containing wastewater 252 to remove most of fluoride in the high concentration fluoride-containing wastewater 101 by cryolite crystallizing in the reaction tank 221. The mixture 250 was temporarily stored in a reaction solution storage tank 224 of the second basic module 220′ connected with the reaction tank 221.

Next, as shown in FIG. 12, the mixture 250 of unextracted cryolite crystals 251 and a low-concentration fluoride-containing wastewater 252 was transported from the reaction solution storage tank 224 to the third basic module 305 of the extracting module 300 to separate into cryolite crystals 311 with a water content less than 60% and a filtrate 315 by the dehydrator 310. The cryolite crystals 311 with a water content less than 60% was transported to the cryolite crystals collecting tank 320 to temporarily stored, and the filtrate 315 was transported to the filtrate collecting tank 340 to temporarily stored and transported to the filtrate concentrator 350 thereafter to concentrate to generate a wastewater 380 that meets the discharge standard and a condensed fluoride-containing liquid 390. The condensed fluoride-containing liquid 390 was recycled to the fluoride-containing wastewater collecting tank 212 of the first basic module 210 of the fluoride removal module 200′ thereafter.

When a high concentration fluoride-containing wastewater 101 having a fluoride concentration higher than for example 15% by weight (150000 ppm) was treated by the modularized fluoride-containing wastewater treating apparatus 10 of Embodiment of this present invention, a low-concentration fluoride-containing wastewater 252 having a fluoride concentration less than 5000 ppm can be generated. A filtrate 315 having a fluoride concentration less than 3000 ppm can be generated when the low-concentration fluoride-containing wastewater 252 having a fluoride concentration less than 5000 ppm was treated by the dehydrator 340 of the third basic module 305 of the extracting module 300. A wastewater 380 having a fluoride concentration less than 5 ppm that meets the discharge standard and a condensed fluoride-containing liquid 390 having a fluoride concentration higher than 3% by weight (30000 ppm) were obtained when the filtrate 315 having a fluoride concentration less than 3000 ppm was further concentrated by the filtrate concentrator 350 of the third basic module 305 of the extracting module 300.

Furthermore, the modularized fluoride-containing wastewater treating apparatus 50 shown in FIG. 12 comprises a fluoride removal module 200′ with one first basic module 210 and one second basic module 220′, and an extracting module 300 with one third basic module 305, but the fluoride removal module 200′ can be equipped with more than one first basic module 210 and second basic module 220′, and the extracting module 300 can be equipped with more than one third basic module 305 when the capacity of the high-concentration fluoride-containing wastewater to be treated is large.

### Embodiment 6

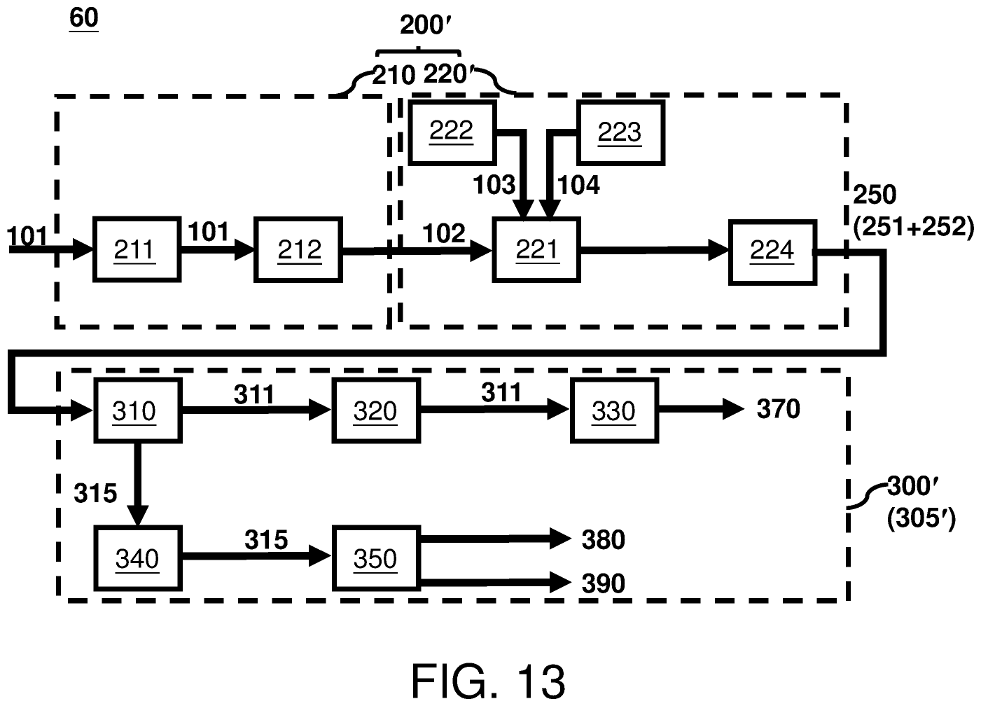

Please refer to FIG. 13, which illustrates a schematic diagram of the modularized fluoride-containing wastewater treating apparatus 60 according to Embodiment 6 of this present invention. As shown in FIG. 13, the modularized fluoride-containing wastewater treating apparatus 60 comprises a fluoride removal module 200′ shown in FIG. 3 and an extracting module 300′ shown in FIG. 5. The high concentration fluoride-containing wastewater 101 transported to the fluoride removal module 200 was treated by the first basic module 210 of the fluoride removal module 200 to generate an adjusted fluoride-containing wastewater 102 with fluoride concentration less than 20% by weight and having a pH value in the range of 3 and 6. The adjusted fluoride-containing wastewater 102 was transported to the second basic module 220 of the fluoride removal module 200 and well-stirred with the mixture 103 of the sodium salt solution and the aluminium salt solution from the first reagent tank 222 and the basic solution 104 from the second reagent feeding tank 223 flow into the reaction tank 221 to generate a reaction solution with a pH value in the range of 3 and 6, and generate a mixture 250 of unextracted cryolite crystals 251 and a low-concentration fluoride-containing wastewater 252 to remove most of fluoride in the high concentration fluoride-containing wastewater 101 by cryolite crystallizing in the reaction tank 221. The mixture 250 was temporarily stored in a reaction solution storage tank 224 of the second basic module 220′ connected with the reaction tank 221.

Next, as shown in FIG. 13, the mixture 250 of unextracted cryolite crystals 251 and a low-concentration fluoride-containing wastewater 252 was transported from the reaction solution storage tank 224 to the third basic module 305′ of the extracting module 300′ to separate into cryolite crystals 311 with a water content less than 60% and a filtrate 315 by the dehydrator 310. The cryolite crystals 311 with a water content less than 60% was transported to the cryolite crystals collecting tank 320 to temporarily stored and then transported to the cryolite crystals drier 330 to dry to generate cryolite crystals 370 with a water content less than 10% and a purity of 95%, and the filtrate 315 was transported to the filtrate collecting tank 340 to temporarily stored and transported to the filtrate concentrator 350′ thereafter to concentrate to generate a wastewater 380 that meets the discharge standard and a condensed fluoride-containing liquid 390. The condensed fluoride-containing liquid 390 was recycled to the fluoride-containing wastewater collecting tank 212 of the first basic module 210 of the fluoride removal module 200′ thereafter.

When a high concentration fluoride-containing wastewater 101 having a fluoride concentration higher than for example 15% by weight (150000 ppm) was treated by the modularized fluoride-containing wastewater treating apparatus 60 of Embodiment of this present invention, a low-concentration fluoride-containing wastewater 252 having a fluoride concentration less than 5000 ppm can be generated. A filtrate 315 having a fluoride concentration less than 3000 ppm and cryolite crystals 370 with a water content less than 10% and a purity of 95% can be generated when the low-concentration fluoride-containing wastewater 252 having a fluoride concentration less than 5000 ppm was treated by the dehydrator 340 of the third basic module 305′ of the extracting module 300′. A wastewater 380 having a fluoride concentration less than 5 ppm that meets the discharge standard and a condensed fluoride-containing liquid 390 having a fluoride concentration higher than 3% by weight (30000 ppm) were obtained when the filtrate 315 having a fluoride concentration less than 3000 ppm was further concentrated by the filtrate concentrator 350 of the third basic module 305′ of the extracting module 300′.

Moreover, the third basic module 305′ of the extracting module 300′ of this present Embodiment 6 can further comprise a cryolite crystals package apparatus (not shown) connected with the cryolite crystals drier 330 to package the cryolite crystals 370 with a water content less than 10% and a purity of 95%.

Furthermore, the modularized fluoride-containing wastewater treating apparatus 60 shown in FIG. 13 comprises a fluoride removal module 200′ with one first basic module 210 and one second basic module 220′, and an extracting module 300′ with one third basic module 305′, but the fluoride removal module 200′ can be equipped with more than one first basic module 210 and second basic module 220′, and the extracting module 300′ can be equipped with more than one third basic module 305′ when the capacity of the high-concentration fluoride-containing wastewater to be treated is large.

### Embodiment 7

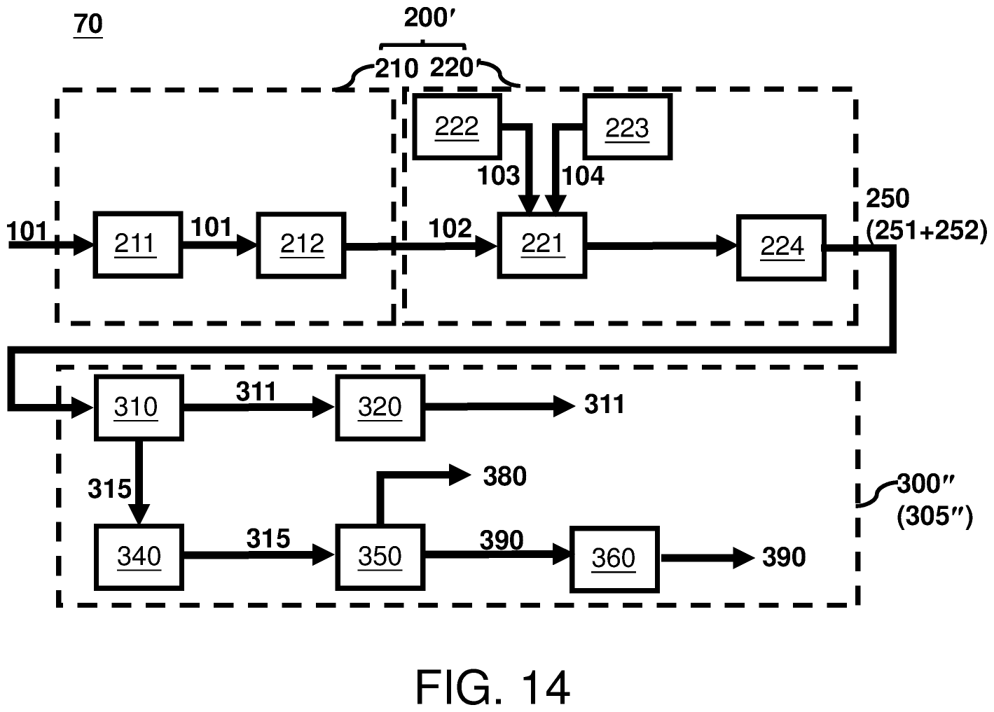

Please refer to FIG. 14, which illustrates a schematic diagram of the modularized fluoride-containing wastewater treating apparatus 70 according to Embodiment 7 of this present invention. As shown in FIG. 14, the modularized fluoride-containing wastewater treating apparatus 70 comprises a fluoride removal module 200′ shown in FIG. 3 and an extracting module 300″ shown in FIG. 6. The high concentration fluoride-containing wastewater 101 transported to the fluoride removal module 200′ was treated by the first basic module 210 of the fluoride removal module 200′ to generate an adjusted fluoride-containing wastewater 102 with fluoride concentration less than 20% by weight and having a pH value in the range of 3 and 6. The adjusted fluoride-containing wastewater 102 was transported to the second basic module 220′ of the fluoride removal module 200′ and well-stirred with the mixture 103 of the sodium salt solution and the aluminium salt solution from the first reagent tank 222 and the basic solution 104 from the second reagent feeding tank 223 flow into the reaction tank 221 to generate a reaction solution with a pH value in the range of 3 and 6, and generate a mixture 250 of unextracted cryolite crystals 251 and a low-concentration fluoride-containing wastewater 252 to remove most of fluoride in the high concentration fluoride-containing wastewater 101 by cryolite crystallizing in the reaction tank 221. The mixture 250 was temporarily stored in a reaction solution storage tank 224 of the second basic module 220′ connected with the reaction tank 221.

Next, as shown in FIG. 14, the mixture 250 of unextracted cryolite crystals 251 and a low-concentration fluoride-containing wastewater 252 was transported from the reaction solution storage tank 224 to the third basic module 305″ of the extracting module 300″ to separate into cryolite crystals 311 with a water content less than 60% and a filtrate 315 by the dehydrator 310. The cryolite crystals 311 with a water content less than 60% was transported to the cryolite crystals collecting tank 320 to temporarily stored and then transported to the cryolite crystals drier 330 to dry to generate cryolite crystals 370 with a water content less than 10% and a purity of 95%, and the filtrate 315 was transported to the filtrate collecting tank 340 to temporarily stored and transported to the filtrate concentrator 350 thereafter to concentrate to generate a wastewater 380 that meets the discharge standard and a condensed fluoride-containing liquid 390. The condensed fluoride-containing liquid 390 stored in a condensed fluoride-containing liquid collecting tank 360. The condensed fluoride-containing liquid 390 was recycled from the condensed fluoride-containing liquid collecting tank 360 to the fluoride-containing wastewater collecting tank 212 of the first basic module 210 of the fluoride removal module 200′ thereafter.

When a high concentration fluoride-containing wastewater 101 having a fluoride concentration higher than for example 15% by weight (150000 ppm) was treated by the modularized fluoride-containing wastewater treating apparatus 30 of Embodiment of this present invention, a low-concentration fluoride-containing wastewater 252 having a fluoride concentration less than 5000 ppm can be generated. A filtrate 315 having a fluoride concentration less than 3000 ppm can be generated when the low-concentration fluoride-containing wastewater 252 having a fluoride concentration less than 5000 ppm was treated by the dehydrator 340 of the third basic module 305″ of the extracting module 300″. A wastewater 380 having a fluoride concentration less than 5 ppm that meets the discharge standard and a condensed fluoride-containing liquid 390 having a fluoride concentration higher than 3% by weight (30000 ppm) were obtained when the filtrate 315 having a fluoride concentration less than 3000 ppm was further concentrated by the filtrate concentrator 350 of the third basic module 305″ of the extracting module 300″.

Furthermore, the modularized fluoride-containing wastewater treating apparatus 70 shown in FIG. 14 comprises a fluoride removal module 200′ with one first basic module 210 and one second basic module 220′, and an extracting module 300″ with one third basic module 305″, but the fluoride removal module 200′ can be equipped with more than one first basic module 210 and second basic module 220′, and the extracting module 300″ can be equipped with more than one third basic module 305″ when the capacity of the high-concentration fluoride-containing wastewater to be treated is large.

### Embodiment 8

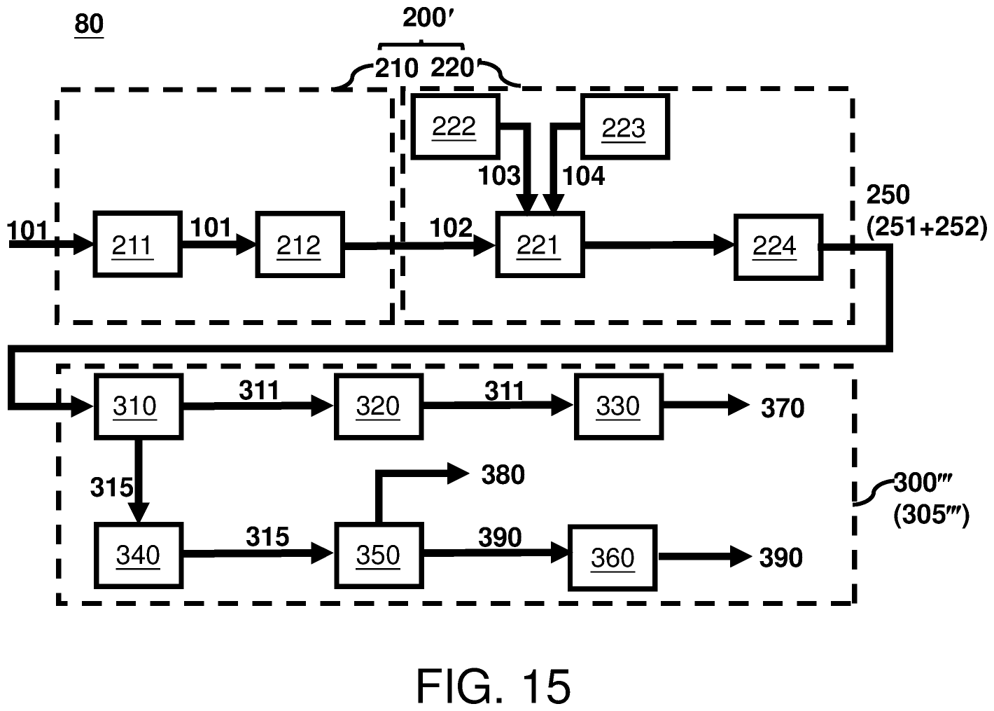

Please refer to FIG. 15, which illustrates a schematic diagram of the modularized fluoride-containing wastewater treating apparatus 80 according to Embodiment 8 of this present invention. As shown in FIG. 15, the modularized fluoride-containing wastewater treating apparatus 80 comprises a fluoride removal module 200′ shown in FIG. 3 and an extracting module 300″ shown in FIG. 7. The high concentration fluoride-containing wastewater 101 transported to the fluoride removal module 200′ was treated by the first basic module 210 of the fluoride removal module 200′ to generate an adjusted fluoride-containing wastewater 102 with fluoride concentration less than 20% by weight and having a pH value in the range of 3 and 6. The adjusted fluoride-containing wastewater 102 was transported to the second basic module 220′ of the fluoride removal module 200′ and well-stirred with the mixture 103 of the sodium salt solution and the aluminium salt solution from the first reagent tank 222 and the basic solution 104 from the second reagent feeding tank 223 flow into the reaction tank 221 to generate a reaction solution with a pH value in the range of 3 and 6, and generate a mixture 250 of unextracted cryolite crystals 251 and a low-concentration fluoride-containing wastewater 252 to remove most of fluoride in the high concentration fluoride-containing wastewater 101 by cryolite crystallizing in the reaction tank 221. The mixture 250 was temporarily stored in a reaction solution storage tank 224 of the second basic module 220′ connected with the reaction tank 221.

Next, as shown in FIG. 15, the mixture 250 of unextracted cryolite crystals 251 and a low-concentration fluoride-containing wastewater 252 was transported from the reaction solution storage tank 224 to the third basic module 305″ of the extracting module 300″ to separate into cryolite crystals 311 with a water content less than 60% and a filtrate 315 by the dehydrator 310. The cryolite crystals 311 with a water content less than 60% was transported to the cryolite crystals collecting tank 320 to temporarily stored and then transported to the cryolite crystals drier 330 to dry to generate cryolite crystals 370 with a water content less than 10% and a purity of 95%, and the filtrate 315 was transported to the filtrate collecting tank 340 to temporarily stored and transported to the filtrate concentrator 350 thereafter to concentrate to generate a wastewater 380 that meets the discharge standard and a condensed fluoride-containing liquid 390 stored in a condensed fluoride-containing liquid collecting tank 360. The condensed fluoride-containing liquid 390 was recycled from the condensed fluoride-containing liquid collecting tank 360 to the fluoride-containing wastewater collecting tank 212 of the first basic module 210 of the fluoride removal module 200′ thereafter.

When a high concentration fluoride-containing wastewater 101 having a fluoride concentration higher than for example 15% by weight (150000 ppm) was treated by the modularized fluoride-containing wastewater treating apparatus 80 of Embodiment of this present invention, a low-concentration fluoride-containing wastewater 252 having a fluoride concentration less than 5000 ppm can be generated. A filtrate 315 having a fluoride concentration less than 3000 ppm and cryolite crystals 370 with a water content less than 10% and a purity of 95% can be generated when the low-concentration fluoride-containing wastewater 252 having a fluoride concentration less than 5000 ppm was treated by the dehydrator 340 of the third basic module 305″ of the extracting module 300″. A wastewater 380 having a fluoride concentration less than 5 ppm that meets the discharge standard and a condensed fluoride-containing liquid 390 having a fluoride concentration higher than 3% by weight (30000 ppm) were obtained when the filtrate 315 having a fluoride concentration less than 3000 ppm was further concentrated by the filtrate concentrator 350 of the third basic module 305″ of the extracting module 300″.

Moreover, the third basic module 305″ of the extracting module 300″ of this present Embodiment 4 can further comprise a cryolite crystals package apparatus (not shown) connected with the cryolite crystals drier 330 to package the cryolite crystals 370 with a water content less than 10% and a purity of 95%.

Furthermore, the modularized fluoride-containing wastewater treating apparatus 80 shown in FIG. 15 comprises a fluoride removal module 200′ with one first basic module 210 and one second basic module 220′, and an extracting module 300″ with one third basic module 305″, but the fluoride removal module 200′ can be equipped with more than one first basic module 210 and second basic module 220′, and the extracting module 300″ can be equipped with more than one third basic module 305″ when the capacity of the high-concentration fluoride-containing wastewater to be treated is large.

To sum up, the water treating apparatuses as mentioned above have three advantages as follows:

1. MODULIZED APPARATUS: The above-mentioned modularized fluorine-containing wastewater treatment apparatus according to this present invention comprises a defluorination module including a first basic module and a second basic modules, and an extraction module including a third basic module. Therefore, there is no need to build a complex fluorine-containing wastewater treatment system in the plant itself, and it can be quickly replicated and installed in a large number of standardized plants, and the numbers of the first basic module, the second basic module and the third basic module can be quickly expanded based on the capacity of high-concentration fluorine-containing wastewater discharged by the plant to enhance the treating capacity of the high-concentration fluorine-containing wastewater. According to the above-mentioned modularized fluorine-containing wastewater treatment apparatus according to this present invention, not only fundamentally solving the possible environmental risks and derivative environmental problems caused by outsourcing cleaning and transportation, but also avoiding human error and danger such as mixing hydrofluoric acid into the wastewater treatment plant by use of human-machine interface/automatic mode operation. Therefore, the amount of water available for water recycling can be effectively enhanced and the treatment cost of subsequent water recycling can be reduced, and the problems suffering by the current fluorine-containing wastewater treatment apparatus can be solved, and the purpose of energy saving and waste reduction can be achieved.

2. PRODUCING CRYOLITE CRYSTALS BY-PRODUCTS WITH HIGH ECONOMIC VALUE: After the high-concentration fluorine-containing wastewater is treated by the above-mentioned modulated fluorine-containing wastewater treatment apparatus according to this present invention, not only wastewater that meets the discharge standard (fluoride ion concentration less than 5 ppm) can be obtained, but also cryolite crystals by-products with high economic value instead sludge with no recycling value are produced. The cryolite crystals by-products with high economic value can be used as a cosolvent for aluminium electrolytic refining and steelmaking, ceramics, insecticides, insulating materials, brighteners, wear-resistant agents, etc. Accordingly, the treatment cost of high-concentration fluorine-containing wastewater can be highly reduced.

3. CIRCULAR TREATMENT TO HARMLESSNESS: As mentioned above, after the high-concentration fluorine-containing wastewater is treated by the above-mentioned modular fluorine-containing wastewater treatment apparatus according to this present invention, wastewater that meets the discharge standard (fluoride ion concentration less than 5 ppm) and cryolite crystals by-products with high economic value can be obtained, and the fluorine-containing concentrated waste liquid produced after being concentrated by the third basic module in the extraction module will be recycled to the defluorination module to circularly remove most of the fluoride in the high-concentration fluoride-containing wastewater by the first basic module, the second basic module and the third basic module until the wastewater that meets the discharge standard (fluoride ion concentration is less than 5 ppm) is obtained.

Although particular embodiments have been shown and described, it should be understood that the above discussion is not intended to limit the present invention to these embodiments. Persons skilled in the art will understand that various changes and modifications may be made without departing from the scope of the present invention as literally and equivalently covered by the following claims.

What is claimed is:

1. A modularized fluoride-containing wastewater treating apparatus, comprising:
a fluoride removal module, which is used to remove most of fluoride in a high-concentration fluoride-containing wastewater transported to the fluoride removal module by cryolite crystallizing to generate a mixture of unextracted cryolite crystals and a low-concentration fluoride-containing wastewater; and
an extracting module connected with the fluoride removal module, which is used to extract the mixture of the unextracted cryolite crystals and the low-concentration fluoride-containing wastewater to separate cryolite crystals with a water content less than 60% or cryolite crystals with a water content less than 10% and a purity of 95%, a wastewater that meets the discharge standard and a condensed fluoride-containing liquid, wherein the condensed fluoride-containing liquid will be recycled to the fluoride removal module.

2. The modularized fluoride-containing wastewater treating apparatus as claimed in claim 1, wherein the fluoride removal module comprises:
a first basic module, comprising a fluoride-containing wastewater collecting tank and an adjusting tank, wherein the fluoride-containing wastewater collecting tank is used to collect a high concentration fluoride-containing wastewater, and the adjusting tank is connected with the fluoride-containing wastewater collecting tank and used to adjust the pH value and fluoride concentration of the high concentration fluoride-containing wastewater from the fluoride-containing wastewater collecting tank to generate an adjusted fluoride-containing wastewater with fluoride concentration less than 20% by weight and having a pH value in the range of 3 and 6; and
a second basic module connected with the first basic module, comprising a reaction tank, a first reagent feeding tank and second reagent feeding tank, wherein the reaction tank is connected with the adjusting tank of the first basic module, and the first reagent feeding tank and the second reagent feeding tank are respectively connected with the reaction tank, and the first reagent feeding is stored with a mixture of a sodium salt solution and an aluminium salt solution, and the second reagent feeding tank is stored with a basic solution, and the first reagent feeding tank and the second reagent feeding tank are respectively open to make the mixture of the sodium salt solution and the aluminium salt solution from the first reagent tank and the basic solution from the second reagent feeding tank flow into the reaction tank when the adjusted fluoride-containing wastewater from the adjusting tank of the first basic module is transported to the reaction tank to generate a reaction solution with a pH value in the range of 3 and 6 after stirring, and generate a mixture of unextracted cryolite crystals and a low-concentration fluoride-containing wastewater by cryolite crystallizing;
wherein the fluoride concentration of the low-concentration fluoride-containing wastewater is lower than that of the high-concentration fluoride-containing wastewater.

3. The modularized fluoride-containing wastewater treating apparatus as claimed in claim 2, wherein the sodium salt is a water-soluble sodium salt selected from one of the group consisting of sodium carbonate, sodium hydroxide, sodium sulfate and sodium nitrite, or combinations thereof.

4. The modularized fluoride-containing wastewater treating apparatus as claimed in claim 2, wherein the aluminium salt is a water-soluble aluminium salt selected from one of the group consisting of aluminium hydroxide, aluminium sulfate and aluminium nitrite, or combination thereof.

5. The modularized fluoride-containing wastewater treating apparatus as claimed in claim 2, wherein the mole ratio between sodium ions, aluminium ions and fluoride ions in the reaction solution is 3:1:6.

6. The modularized fluoride-containing wastewater treating apparatus as claimed in claim 2, the adjusting tank is made of polytetrafluoroethylene (PTFE).

7. The modularized fluoride-containing wastewater treating apparatus as claimed in claim 2, wherein the reaction tank is a fluidized crystallization bed with a plurality of carriers, and the unextracted cryolite crystals are grown on the carriers.

8. The modularized fluoride-containing wastewater treating apparatus as claimed in claim 2, wherein the reaction tank is made of polytetrafluoroethylene (PTFE) and corrosion resisting stainless.

9. The modularized fluoride-containing wastewater treating apparatus as claimed in claim 2, wherein the first reagent feeding tank and the second reagent feeding tank are made of fiber-reinforced plastic (FRP).

10. The modularized fluoride-containing wastewater treating apparatus as claimed in claim 2, wherein the second basic module further comprises a reaction solution storage tank connected with the reaction tank to temporarily store the mixture of unextracted cryolite crystals and the low-concentration fluoride-containing wastewater generate by the reaction tank.

11. The modularized fluoride-containing wastewater treating apparatus as claimed in claim 2, wherein the extracting module further comprises a third basic module connected with the second basic module of the fluoride removal module, comprising:
a dehydrator connected with the reaction tank of the second basic module;
a cryolite crystals collecting tank connected with the dehydrator;
a filtrate collecting tank connected with the dehydrator; and
a filtrate concentrator connected with the filtrate collecting tank and the fluoride-containing wastewater collecting tank of the first basic module;
wherein the mixture of unextracted cryolite crystals and the low-concentration fluoride-containing wastewater transported from the reaction tank is separated into cryolite crystals with a water content less than 60% and a filtrate by the dehydrator, and the cryolite crystals with a water content less than 60% is transported to the cryolite crystals collecting tank to temporarily stored, and the filtrate is transported to the filtrate collecting tank to temporarily stored and transported to the filtrate concentrator thereafter to concentrate to generate a wastewater that meets the discharge standard and a condensed fluoride-containing liquid, wherein the condensed fluoride-containing liquid will be recycled to the fluoride-containing wastewater collecting tank of the first basic module of the fluoride removal module;
wherein the fluoride concentration of the filtrate is lower than that of the high-concentration fluoride-containing wastewater, and the fluoride concentration of the filtrate is lower than that of the condensed fluoride-containing liquid.

12. The modularized fluoride-containing wastewater treating apparatus as claimed in claim 11, wherein the third basic module further comprises a cryolite crystals drier connected with the cryolite crystals collecting tank, and the cryolite crystals with a water content less than 60% transported from the cryolite crystals collecting tank to the cryolite crystals drier are subsequent dried to generate cryolite crystals with a water content less than 10% and a purity of 95%.

13. The modularized fluoride-containing wastewater treating apparatus as claimed in claim 12, wherein the third basic module further comprises a cryolite crystals package apparatus connected with the third basic module further comprises a cryolite crystals drier to package the cryolite crystals with a water content less than 10% and a purity of 95% generate by the cryolite crystals drier.

14. The modularized fluoride-containing wastewater treating apparatus as claimed in claim 11, wherein the third basic module further comprises a condensed fluoride-containing liquid collecting tank connected with the filtrate concentrator and the fluoride-containing wastewater collecting tank of the first basic module, wherein the condensed fluoride-containing liquid generated by the filtrate concentrator is temporarily stored in the condensed fluoride-containing liquid collecting tank and recycled to the fluoride-containing wastewater collecting tank of the first basic module of the fluoride removal module.

15. The modularized fluoride-containing wastewater treating apparatus as claimed in claim 10, wherein the extracting module further comprises a third basic module connected with the second basic module of the fluoride removal module, comprising:
a dehydrator connected with the reaction solution storage tank of the second basic module;
a cryolite crystals collecting tank connected with the dehydrator;
a filtrate collecting tank connected with the dehydrator; and
a filtrate concentrator connected with the filtrate collecting tank and the fluoride-containing wastewater collecting tank of the first basic module;
wherein the mixture of unextracted cryolite crystals and the low-concentration fluoride-containing wastewater transported from the reaction solution storage tank is separated into cryolite crystals with a water content less than 60% and a filtrate by the dehydrator, and the cryolite crystals with a water content less than 60% is transported to the cryolite crystals collecting tank to temporarily stored, and the filtrate is transported to the filtrate collecting tank to temporarily stored and transported to the filtrate concentrator thereafter to concentrate to generate a wastewater that meets the discharge standard and a condensed fluoride-containing liquid, wherein the condensed fluoride-containing liquid will be recycled to the fluoride removal module;
wherein the fluoride concentration of the filtrate is lower than that of the high-concentration fluoride-containing wastewater, and the fluoride concentration of the filtrate is lower than that of the condensed fluoride-containing liquid.

16. The modularized fluoride-containing wastewater treating apparatus as claimed in claim 15, wherein the third basic module further comprises a cryolite crystals drier connected with the cryolite crystals collecting tank, and the cryolite crystals with a water content less than 60% transported from the cryolite crystals collecting tank to the cryolite crystals drier are subsequent dried to generate cryolite crystals with a water content less than 10% and a purity of 95%.

17. The modularized fluoride-containing wastewater treating apparatus as claimed in claim 16, wherein the third basic module further comprises a cryolite crystals package apparatus connected with the third basic module further comprises a cryolite crystals drier to package the cryolite crystals with a water content less than 10% and a purity of 95% generate by the cryolite crystals drier.

18. The modularized fluoride-containing wastewater treating apparatus as claimed in claim 15, wherein the third basic module further comprises a condensed fluoride-containing liquid collecting tank connected with the filtrate concentrator and the fluoride-containing wastewater collecting tank of the first basic module, wherein the condensed fluoride-containing liquid generated by the filtrate concentrator is temporarily stored in the condensed fluoride-containing liquid collecting tank and recycled to the fluoride-containing wastewater collecting tank of the first basic module of the fluoride removal module.
